(19) United States
(12) Patent Application Publication
(10) Pub. No.: US 2006/0181806 A1
(43) Pub. Date: Aug. 17, 2006

(54) Reference head for use in a flexible data storage card

(75) Inventors: Saeed Fahimi, Bloomington, MN (US); Anthony O. Banal, Fergus Falls, MN (US); Geoffrey A. Lauinger, Campbell, MN (US); Kellan D. Pauly, Wahpeton, ND (US)

Correspondence Address: Attention: Eric D. Levinson;Imation Corp., Legal Affairs, P.O. Box 64898, St. Paul, MN, 55164-0898, US

(73) Assignee: Imation Corp.

(21) Appl. No.: 11/058,837

(22) Filed: Feb. 15, 2005

(51) Int. Cl. G11B 5/74; G11B 23/00

(52) U.S. Cl. 360/131

(57) ABSTRACT

Reference heads for use in flexible data storage cards are disclosed. In one embodiment, a reference head includes a planar card surface for attachment to an interior housing surface of a flexible data storage card, and a non-planar reference surface opposite the planar card surface. In one embodiment, a non-symmetric reference head for use in a flexible data storage card housing a rotatable media disc includes a body defining a first planar surface opposite an optically smooth second planar surface, and a location feature formed in the body. In this regard, the location feature is configured to reproducibly orient the optically smooth second planar surface toward the rotatable media disc.

### THE FIELD OF THE INVENTION

The present invention relates to a reference head for use in a flexible data storage card and, more particularly, to a reference head having an optically smooth reference surface that is reproducibly positionable toward a media disc housed within the flexible data storage card.

### BACKGROUND OF THE INVENTION

Data storage media have been used for decades in the computer, audio, and video fields. Data storage media continue to be employed for storing large volumes of information in a form suited for subsequent retrieval and use.

Data storage media are generally provided in one of two forms, long strands of magnetic tape and rotating discs. The rotating disc storage media are of two types: hard disc (HD) media and floppy disc (FD) media. Generally, HD media are maintained within a housing of a data storage device. For example, HD media are commonly maintained within a computer hard drive and accessed via an internal read/write device of the drive. In contrast, FD media are removable from, and interchangeable between, data storage devices. In this regard, FD media have the benefit of being transportable. Typically, a shutter is provided on an exterior portion of the FD to cover and protect the FD media during periods of inactivity and to permit the read/write device to access the FD media during use.

HD media typically comprise rigid discs formed of a metal substrate having a sputter deposition of a magnetic film. Deposition of the magnetic film in this manner permits a very high magnetic recording density to be achieved. During a read/write operation, the HD media are rotated at relatively high speeds (i.e., approximately 10,000 rpm) and “fly” over the read/write head in a non-contact manner.

FD media typically are composed of a plastic substrate, such as Mylar®, that is coated with a slurry of magnetic particles. The FD media can be coated on both sides to form “two-sided” media. In any regard, FD media operate at relatively low speeds (i.e., less than 1000 rpm) and the read/write head contacts the FD media. To facilitate good wear characteristics, the magnetic slurry contains a binder and a bulk lubricant along with the magnetic particles. Commonly, FD media are provided to users in an industry-accepted format, such as 3.5 inch floppy discs. While universally accepted, these formats are not convenient to handle and carry, have limited storage capacity, and do not provide durable protection for the FD media.

More recently, efforts have been made to provide a conveniently sized, robust storage media offering advantages of both the HD and FD media. In particular, a transportable data storage card having a form factor of approximately the size of a credit card has been developed that includes a flexible one-sided data storage media in the form of a disc. Such a device is known as a “flexible data storage card” and has mechanical flexibility in both the longitudinal and transverse directions. A flexible data storage card described by StorCard, Inc., San Jose, Calif., under the trademark StorCard® is one example.

Generally, the StorCard® flexible data storage card consists of an outer shell or housing that maintains the flexible media disc. The housing normally includes a separate cover and a separate base that encloses the flexible media, fabric liners, and other components. The cover is known as a card top and is formed of a plastic laminate and includes an integrated circuit that monitors the flow of data into, and out of, the flexible storage card. The base is a thin metallic structure that is laminated to the card top to form the housing structure. A window is provided on the base and includes a shutter that provides selective access to the flexible media disc by an external read/write head.

During use, the shutter in the base is displaced to provide access to the flexible media disc by the read/write head. The flexible media disc rotates at approximately 4000 rotations per minute (rpm), thereby attaining a high velocity at an outer edge of the disc. The high velocity of the rotating disc is desirable and creates an “air bearing” between the flexible media disc and the read/write head, and the read/write head is said to “fly” over the flexible media disc.

The air bearing is comprised of aerodynamic forces. Imbalances and/or perturbations in the aerodynamic forces can cause the flexible media disc to “crash” or “plow” into the read/write head, and such contact could lead to catastrophic damage to the flexible media disc and the data stored thereon. As a point of reference, when the read/write head projects into the window formed in the base, the flexible media disc is deflected away from the read/write head. To assist in maintaining a position of the read/write head over the flexible media disc, a reference head is provided on an interior side of the card top in a position opposite the shutter/window of the base (i.e., opposite of the read/write head). In this manner, the flexible media disc is disposed between the reference head and the shutter/window when the flexible data storage card is stowed, and the flexible media disc is disposed between the reference head and the read/write head when the flexible data storage card is accessed.

The reference head is generally an elongated piece of non-magnetic metal attached to the card top interior. In particular, the reference head is situated adjacent the side of the flexible media disc that is not coated with magnetic media. Positioned in this manner, the flexible media disc “flies” between the read/write head and the reference head during a read/write operation such that air bearings are aerodynamically formed between both the read/write head and the disc and the reference head and the disc. Consequently, the side of the reference head exposed to the disc must have a very smooth surface topography to ensure that the aerodynamic air bearing is not disturbed.

Prior art reference heads are known to cause aerodynamic pressure to build over a footprint of the reference head during read/write operations. In addition, the aerodynamic pressure immediately outside the footprint of the reference head also increases as rotation of the flexible media disc entrains the local air into a narrower, convergent flow path in the vicinity of the reference head. This increased aerodynamic pressure immediately outside the footprint of the reference head can initiate a wobble in the rotation of the flexible media disc, thus increasing the likelihood of the flexible media disc plowing or crashing into the read/write head.

Flexible data storage cards offer the durable transportation of high-density data storage media. However, the prior art reference heads employed in flexible data storage cards have shortcomings. For example, it is difficult in a manufacturing setting to reproducibly position the prior art reference head within the storage card such that the highly smooth surface faces toward the flexible media disc. In addition, the prior art reference heads can cause aerodynamic pressure to build around the reference head resulting in the flexible media disc potentially plowing or crashing into the read/write head. Therefore, a need exists for an improved reference head for use in flexible data storage cards.

### SUMMARY OF THE INVENTION

One aspect of the present invention relates to a flexible data storage card. The flexible data storage card includes a card top and a base coupled together to form a housing, a media disc rotatably disposed within the housing, and a reference head disposed within the housing. The media disc includes a media side opposite a non-media side, and the reference head defines a planar card surface opposite a non-planar reference surface. In this regard, the planar card surface is coupled to an interior surface of the card top such that the non-planar reference surface is adjacent the non-media side of the media disc.

Another aspect of the present invention relates to a reference head for use in a flexible data storage card. In this regard, the reference head includes a planar card surface for attachment to an interior housing surface of the flexible data storage card, and a non-planar reference surface opposite the planar card surface.

Yet another aspect of the present invention relates to a non-symmetric reference head for use in a flexible data storage card housing a rotatable media disc. The non-symmetric reference head includes a body and a location feature formed in the body. The body defines a first planar surface opposite an optically smooth second planar surface. In this regard, the location feature is configured to reproducibly orient the optically smooth second planar surface toward the rotatable media disc.

### BRIEF DESCRIPTION OF THE DRAWINGS

Embodiments of the invention are better understood with reference to the following drawings. The elements of the drawings are not necessarily to scale relative to each other. Like reference numerals designate corresponding similar parts.

FIG. 1 is a perspective, exploded view of a simplified flexible data storage card according to one embodiment of the present invention;

FIG. 2 is a plan view of an underside of a card top of a flexible data storage card showing a reference head;

FIG. 3 is a perspective view of a reference head according to one embodiment of the present invention;

FIG. 4 is a side view of the reference head shown in FIG. 3;

FIG. 5 is a perspective view of a reference head according to another embodiment of the present invention;

FIG. 6 is a side view of the reference head shown in FIG. 5;

FIG. 7 is a perspective view of a reference head according to yet another embodiment of the present invention;

FIG. 8 is a simplified side view of an information read/write system including a read/write head in equilibrium relative to a reference head according to one embodiment of the present invention;

FIG. 9 is a perspective view of a non-symmetric reference head according to one embodiment of the present invention; and

FIG. 10 is a top plan view of the non-symmetric reference head shown in FIG. 9.

### DETAILED DESCRIPTION OF THE PREFERRED EMBODIMENTS

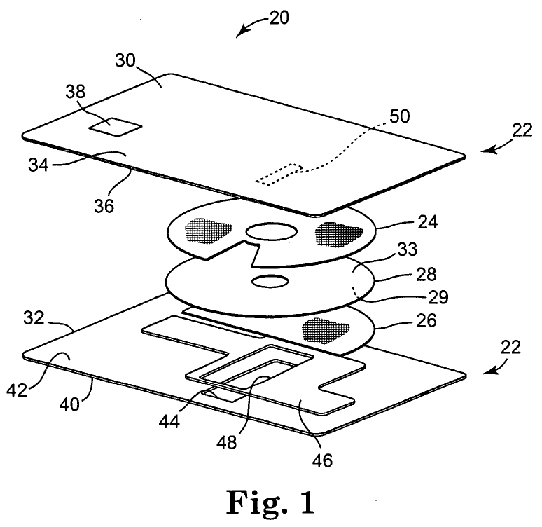

A simplified flexible data storage card, representative of data storage cards advertised under the trademark StorCard® and according to one embodiment of the present invention, is illustrated in an exploded, perspective view at 20 in FIG. 1. The flexible data storage card 20 as offered by StorCard, Inc., San Jose, Calif. includes a housing 22, a first wiping pad 24, a second wiping pad 26, and a flexible media disc 28. The flexible media disc 28 is coated on a media side 29 with a magnetic media. When assembled, the flexible media disc 28 is rotatably disposed within the housing 22. Notably, the flexible data storage card 20 of FIG. 1 is but one example of an acceptable configuration with which the present invention is useful. That is to say, the present invention can be employed in conjunction with other flexible data storage card designs that may or may not be offered by StorCard, Inc., and can include additional features and/or components not otherwise illustrated in FIG. 1.

The housing 22 is sized to be transportable and has a form factor that approximates the size of a credit card. Thus, the housing 22 has a size of approximately 86 mm×54 mm×0.8 mm, although other dimensions are equally acceptable. With this in mind, a card top 30 and a base 32 combine to define the housing 22. In one embodiment, the card top 30 forms a cover and the base 32 forms a bottom. As used thoughout the specification, directional terminology such as “cover,” “base,” “upper,” “lower,” “top,” “bottom,” etc., is employed for purposes of illustration only and is in no way limiting.

The first wiping pad 24 and the second wiping pad 26 are of a type known in the art and are generally characterized as soft fibrous sheets that are configured to capture dust and debris generated when the flexible media disc 28 rotates between the wiping pads 24, 26. The wiping pads 24, 26 can be either woven or non-woven fibrous pads, and are preferably formed to be non-linting.

The flexible media disc 28 (hereinafter media disc 28) is of a type known in the art and generally includes a thin sheet of polyester or similar material having a non-media side 33 opposite the media side 29. In this regard, in one embodiment the media side 29 is coated with a magnetic slurry configured to magnetically record information when dry. In general, the non-media side 33 is not coated with a magnetic slurry, although the non-media side 33 can include one or more other coated layers (for example, a lubricant layer). For example, in one embodiment the media disc 28 is a thin sheet of polyester approximately 0.003 inch thick and includes a slurry-coated layer of magnetic particles on the media side 29.

The card top 30 and the base 32 are reciprocally mated to one another and are generally rectangular. The card top 30 defines an exterior surface 34 and an interior surface 36. In one embodiment, an electronic chip 38 is mounted to the exterior surface 34 of the card top 30 and controls the flow of data to and from the flexible data storage card 20. In a similar fashion, the base 32 defines an outer surface 40 and an inner surface 42. The card top 30 is generally formed of a thin laminate of plastic and metal layers, whereas the base 32 is generally formed of a laminate of thin metallic layers. As an example, the card top 30 and the base 32 can each be formed from two layers, each of the layers having a thickness of about 0.003 inch, such that when assembled, the housing 22 is flexible. After assembly, the flexible data storage card 20 is transportable, and can be, for example, carried in a wallet and flexed in both the transverse and longitudinal directions without damaging the media disc 28.

Additionally, an access window 44 is formed in the base 32 to permit access by a read/write head (not shown) to the media side 29 of the media disc 28. To this end, a shutter 46 is provided on the inner surface 42 and defines a shutter window 48 that is configured to permit selective access by a read/write head (not shown) to the media side 29 of disc 28 when the shutter window 48 is at least partially aligned with the access window 44.

A reference head 50 is provided on the interior surface 36 of the card top 30. In this regard, the reference head 50 is preferably positioned opposite the shutter 46 and opposite the media side 29 of the media disc 28 when the flexible data storage card 20 is assembled. In this manner, when the media disc 28 spins during a read/write operation, the media disc 28 is constrained to a reference position between a read/write head (not shown) disposed within the shutter window 48 and the reference head 50.

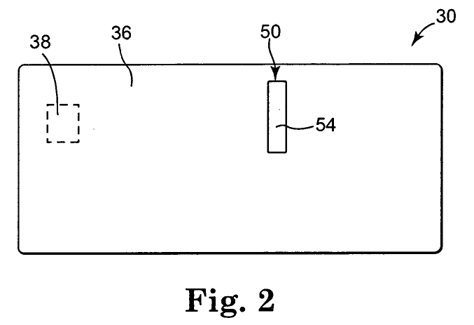

A plan view of the interior surface 36 of the card top 30 is illustrated in FIG. 2. Specifically, the card top 30 has been removed and inverted to display the interior surface 36. Attached to the interior surface 36 is the reference head 50. A planar surface of the reference head 50 can be attached to the interior surface 36 of the card top 30 such that a non-planar reference surface 54 is exposed (i.e., “up” relative to FIG. 2), as described in greater detail below. In this regard, the reference head 50 can be attached to the card top 30 by any means that durably bonds the reference head 50 to the interior surface 36. For example, in one embodiment the reference head 50 is physically adhered to the interior surface 36 via glue, or an adhesive, or the like. In another embodiment, the reference head 50 is welded to the interior surface 36, for example, via induction welding or via ultrasonic welding, although other bonding methods are also acceptable.

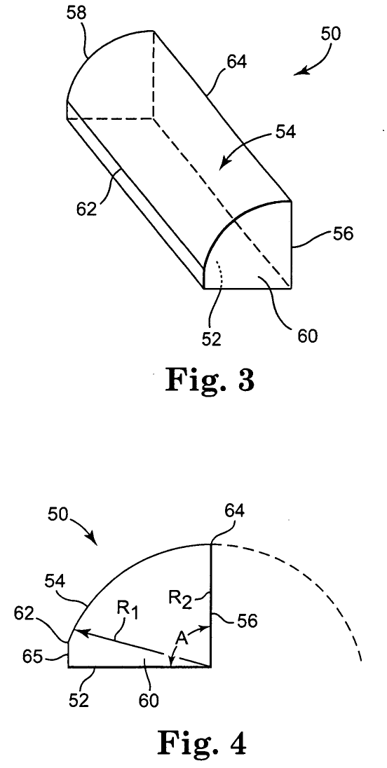

FIG. 3 is a perspective view of the reference head 50 according to one embodiment of the present invention. The reference head 50 includes a planar card surface 52, and the non-planar reference surface 54 opposite the planar card surface 52. In addition, a back surface 56 is defined that extends between the planar card surface 52 and the non-planar reference surface 54, and between a first side 58 and a second side 60.

In one embodiment, the planar card surface 52 defines a rectangular footprint extending a length between the first side 58 and the second side 60, and extending for a width between the sides 58, 60. The non-planar reference surface 54 extends between a leading edge 62 and a trailing edge 64. In one embodiment, leading edge 62 is adjacent the planar card surface 52 and the trailing edge 64 is displaced from (i.e., offset from) the planar card surface 52. In this regard, the back surface 56 extends between the planar card surface 52 and the trailing edge 64. In addition, it is desired that a length of the reference head 50 (e.g., the length between the first side 58 and the second side 60) be sufficiently long to accommodate a trace length of a read/write head, as described more fully below.

With regard to the boundaries of the various surfaces shown in FIG. 3, it is desired that the edges, and in particular the leading edge 62 and the trailing edge 64, include blended radii. Characteristically, reference heads having “sharp” edges can be associated with impact damage (i.e., scratches and/or gouges) in the media disc caused by the reference head “digging” into the media disc when the data storage card is flexed. With this in mind, and as will be appreciated by one of ordinary skill in the reference head art, at least the leading edge 62 and the trailing edge 64 of the reference head 50 include a radius (not shown) configured to remove a sharp corner formed by any two intersecting surfaces.

FIG. 4 is a side view of the reference head 50 directed to the second side 60. The non-planar reference surface 54 extends between the leading edge 62 and the trailing edge 64. In one embodiment, the leading edge 62 is formed at an intersection of the non-planar reference surface 54 and a leading face 65. In this regard, the leading face 65 extends from the planar card surface 52 and is, in one embodiment, parallel to the back surface 56, although other angular orientations are acceptable. In addition, the leading face 65 extends the width of the reference head 50. As a point of reference, in general the leading face 65 extends from the planar card surface 52 by less than approximately 0.25 inch such that the leading edge 62, when not actually contiguous with the planar card surface 52, is in all embodiments adjacent the planar card surface 52.

In one embodiment, the non-planar reference surface 54 defines a curved surface (i.e., an arcuate surface) of constant radius extending between the leading edge 62 and the trailing edge 64 where a first radius R₁ intersects with the leading edge 62, and a second radius R₂ intersects with the trailing edge 64 such that R₁ is equal to R₂. In an alternate embodiment, the first radius R₁ is not equal to the second radius R₂ such that the non-planar reference surface 54 is defined by a curved surface having a varying radius of curvature. In one embodiment, a portion of the non-planar reference surface 54 adjacent the trailing edge 64 is flat (i.e., horizontal with reference to the orientation of FIG. 4). In any regard, the non-planar reference surface 54 extends between the leading edge 62 and the trailing edge 64 through an angular displacement A. In one embodiment, the angular displacement A is not greater than 180 degrees. In a preferred embodiment, the angular displacement A between the planar card surface 52 and the back surface 56 is approximately 90 degrees.

In general, the non-planar reference surface 54 is highly smooth. In one embodiment, the non-planar reference surface 54 is characterized by an average surface roughness of less than 8 micro-inches. In one embodiment, the non-planar reference surface 54 is characterized by an average surface roughness of between 1-8 micro-inches, and preferably the average surface roughness is between 2-6 micro-inches. In general, the non-planar reference surface 54 is characterized by an average surface roughness of not greater than 8 micro-inches.

In addition, by virtue of the non-planar reference surface 54 being curved, when the reference head 50 is assembled into the flexible data storage card 20 (FIG. 1), the non-planar reference surface 54 preferentially orients toward the flexible media disc 28 (FIG. 1) as the planar card surface 52 is easily targeted to repose on the planar interior surface 36 of the card top 30 (FIG. 1). For example, in one embodiment, and with additional reference to FIG. 2, the planar card surface 52 is coupled to the interior surface 36 of the card top 30 such that the non-planar reference surface 54 is exposed. As a point of reference, the orientation of the reference head 50 illustrated in FIG. 2 corresponds to the orientation for the reference head 50 shown in FIG. 3. In particular, the non-planar reference surface 54 is “up” and the leading edge 62 is to the left (relative to the orientation of FIGS. 2 and 3). This desired, “proper” orientation is preferentially achieved as the reference head 50 will wobble when the non-planar reference surface 54 is placed against the card top 30. To this end, the reference head 50 is stable when the planar card surface 52 contacts the planar interior surface 36 of the card top 30, and additionally, the reference head 50 can be reproducibly positioned in this desired orientation by either manual (i.e., human) or automated (i.e., robotic) assembly processes.

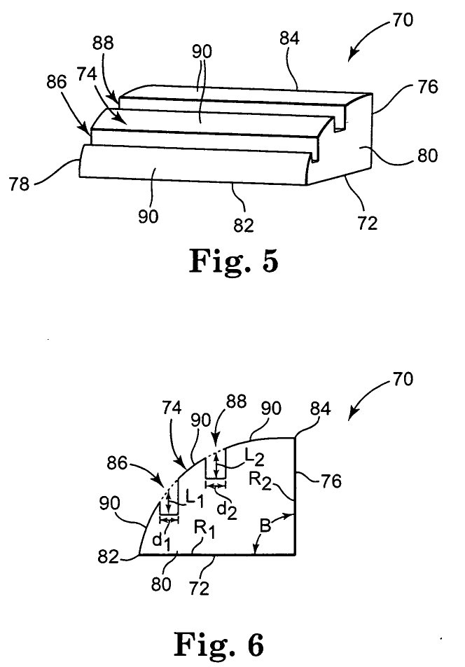

An alternate reference head according to another embodiment of the present invention is illustrated at 70 in FIG. 5. The reference head 70 includes a planar card surface 72 and a non-planar reference surface 74 opposite the planar card surface 72. The planar card surface 72 intersects with a back surface 76. In this regard, the planar card surface 72, the non-planar reference surface 74, and the back surface 76 extend between a first side 78 and a second side 80 of the reference head 70.

The non-planar reference surface 74 extends between a leading edge 82 and a trailing edge 84. In one embodiment, the leading edge 82 is adjacent and coincident with the planar card surface 72, and the trailing edge 84 is adjacent and coincident with the back surface 76, and thus, offset from the planar card surface 72. The non-planar reference surface 74 is generally curved and extends between the leading edge 82 and the trailing edge 84 and, in one embodiment, defines a first air slot 86 and a second air slot 88 that extend between the first side 78 and the second side 80 of the reference head 70. While two air slots 86, 88 are illustrated in FIG. 5, it is to be understood that a single air slot could also be formed in the non-planar reference surface 74, and, moreover, multiplicity air slots could be formed in the non-planar reference surface 74 without departing from the scope of the present invention. With this in mind, in general, at least an exposed outer surface 90 of the non-planar reference surface 74 is highly smooth. In one embodiment, the outer surface 90 of the non-planar reference surface 74 is characterized by an average surface roughness of not greater than 8 micro-inches.

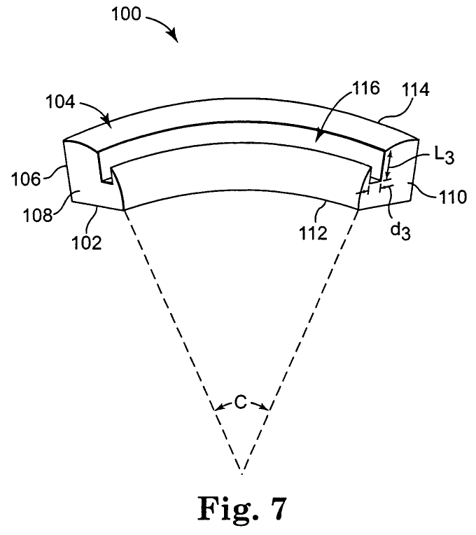

FIG. 6 is a side view of the second side 80 of the reference head 70. The non-planar reference surface 74 extends between the leading edge 82 and the trailing edge 84 and defines the curved outer surface 90 that extends through the angular displacement B. The angular displacement B can be any angle between 0-180 degrees, as noted above with reference to the angular displacement A. In this regard, the non-planar reference surface 74 defines a radius of curvature defined by a first radius R₁ and a second radius R₂. In one embodiment, the first radius R₁ is equal to the second radius R₂ such that the non-planar reference surface 74 defines a curve having a constant radius of curvature. In an alternate embodiment, the first radius R₁ is not equal to the second radius R₂ such that the non-planar reference surface 74 defines a varying radius of curvature. In any regard, by virtue of the non-planar reference surface 74 being curved, when the reference head 70 is assembled into the flexible data storage card 20 (FIG. 1) the optically smooth non-planar reference surface 74 preferentially orients toward the flexible media disc 28 (FIG. 1). That is to say, the reference head 70 will wobble when the non-planar reference surface 74 is placed toward the card top 30 (FIG. 1), but the reference head 70 is stable when the planar card surface 72 contacts the planar interior surface 36 of the card top 30, such that the reference head 70 can be reproducibly positioned in a desired orientation onto the interior surface 36.

In general, the reference surface 74 forms the air slots 86, 88 as channels that extend between the first side 78 and the second side 80. In this regard, for example, the air slot 86 is formed as a channel in the non-planar reference surface 74 having an average depth L₁ and a width d₁. In a like manner, the second air slot 88 is formed as a channel in the non-planar reference surface 74 having an average depth L₂ and a width d₂. In one embodiment, the air slots 86, 88 have approximately equal average depths such that L₁ is equal to L₂. In an alternate embodiment, the first air slot 86 has a depth L₁ that is not equal to the depth L₂ of the second air slot 88. In one embodiment, L₁ and L₂ are selected to be from 0.001 to 0.02 inch. In one embodiment, the air slots 86, 88 have approximately equal average widths such that d₁ is equal to d₂, where d₁ is approximately 0.01 inch. In an alternate embodiment, the first air slot 86 has a width d₁ that is not equal to the width d₂ of the second air slot 88. In one embodiment, d₁ and d₂ are selected to be from 0.005 to 0.02 inch. As a point of reference, the air slots 86, 88 are illustrated as having orthogonal cross-sections, although other shapes and sizes of the cross-section of the air slots 86, 88 are equally acceptable. For example, in one embodiment at least one of the air slots 86, 88 is a U-shaped air slot. In yet another alternate embodiment, at least one of the air slots 86, 88 is V-shaped.

FIG. 7 is a perspective view of an alternate reference head 100 according to another embodiment of the present invention. The reference head 100 includes a planar card surface 102 and a non-planar reference surface 104 opposite the planar card surface 102. A back surface 106 is adjacent and contiguous with the planar card surface 102. In this regard, each of the planar card surface 102, the non-planar reference surface 104, and the back surface 106 extend between a first side 108 and a second side 110.

The non-planar reference surface 104 is generally curved and extends between a leading edge 112 and a trailing edge 114. In one embodiment, the non-planar reference surface 104 defines an air slot 116 extending between the first side 108 and the second side 110. While only one air slot 116 is illustrated in FIG. 7, it is to be understood that a plurality of air slots could be formed by the non-planar reference surface 104.

In a preferred embodiment, the air slot 116 is formed in the non-planar reference surface 104 and is parallel to the leading edge 112. With this in mind, in one embodiment the leading edge 112 and the trailing edge 114 are parallel and define an arcuate shape of constant radius, as more fully described below. In this regard, the planar card surface 102 is also arcuate and defines an arcuate footprint. In any regard, in a preferred embodiment, the non-planar reference surface 104 forms the air slot 116 as a channel having an average depth below the non-planar reference surface 104 of L₃, and a width of d₃. In one embodiment, the depth L₃ is approximately 0.02 inch and the width of d₃ is approximately 0.1 inch. As a point of reference, the air slot 116 is illustrated as having an orthogonal cross-section, although other shapes and sizes of the cross-section of the air slot 116 are equally acceptable. For example, in one embodiment, the air slot 116 is a U-shaped air slot. In yet another embodiment, the air slot 116 is V-shaped.

The non-planar reference surface 104, in one embodiment, is defined by a curve having a constant radius extending between the leading edge 112 and the trailing edge 114. In an alternate embodiment, the non-planar reference surface 104 is defined by a curve having a varying radius of curvature extending between the leading edge 112 and the trailing edge 114.

The leading edge 112 is curvilinear. In a preferred embodiment, the back surface 106 and the trailing edge 114 are parallel to the leading edge 112, and are thus also curvilinear. In particular, the leading edge 112 is curved and extends through an angular displacement of C. In one embodiment, the angular displacement C is less than 180 degrees. In a preferred embodiment, the angular displacement C is less than 60 degrees, more preferably less than 30 degrees, and most preferably approximately 17 degrees. In this regard, the reference head 100 defines a curvilinear planform such that the planar card surface 102 defines an arcuate footprint. The curvilinear planform of the reference head 100 accommodates variability in the position/orientation of a read/write head relative to the reference head 100 during read/write operations.

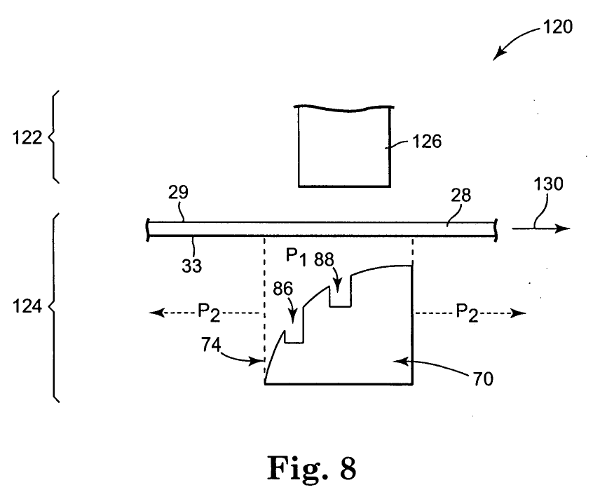

During use, the above-described reference heads can be selectively positioned in a desired orientation onto the interior surface 36 of the card top 30 (FIG. 1) and provide a reference surface that minimizes the pressure buildup outside of a footprint of a data head, as described below with reference to FIG. 8.

FIG. 8 is a simplified side view of an information system 120 according to one embodiment of the present invention; The information system 120 includes a drive 122 and a flexible data storage card 124. The drive 122 is similar to drives employed by users of flexible data storage cards and includes a read/write head 126. The read/write head 126 is shown in a simplified, schematic form in an operational position relative to the flexible data storage card 124. In this regard, the flexible data storage card 124 includes the various components as described above with reference to the flexible data storage card 20 (FIG. 1), and in particular includes the media disc 28 and the exemplary reference head 70 described in FIG. 6 above. It should be noted that certain components of the flexible data storage card 124 have been omitted from FIG. 8 (for example, a base, an access window, and a shutter) for ease of illustration of the information system 120.

With the above in mind, FIG. 8 illustrates the read/write head 126 interacting with the flexible data storage card 124 and positioned opposite of the reference head 70. The media disc 28 is disposed above the reference head 70 and is configured to rotate in a plane above the reference head 70 (i.e., the media disc 28 rotates in a plane perpendicular to the paper relative to FIG. 8). In this regard, an edge of the media disc 28 moves in a lateral direction as indicated by arrow 130 as the media disc rotates. The read/write head 126, during a read/write process, is positioned adjacent the media side 29 of the media disc 28, and the non-media side 33 of the media disc 28 is adjacent the reference head 70. During operation, the read/write head 126 traverses a length of the reference head 70 (i.e., in a direction into the paper of FIG. 8) as the media disc 28 rotates, thus the information system 120 is a dynamic system that benefits from a selective control of the dynamic forces acting on the media disc 28, the reference head 70, and the read/write head 126. As illustrated in FIG. 8, a width of the reference head 70 is generally greater than a width of the read/write head 126.

During use, when the media disc 28 is rotated in a read/write operation, a pressure P₁ within a footprint of the reference head 70 (i.e., within the dotted lines of FIG. 8) can be controlled and maintained, and a pressure P₂ outside of a footprint of the reference head 70 (i.e., outside the dotted lines of FIG. 8) can be controlled and preferably minimized. In particular, it is desired that the pressure P₁ within the footprint of the reference head 70 be greater than the pressure P₂ outside of the footprint of the reference head 70. As a point of reference, it is also desired to maintain the pressure P₂ outside of the footprint of the reference head 70 at a lower relative pressure such that forces on the housing, for example, the housing 22 (FIG. 1), of the flexible data storage card 124 are minimized. In particular, forces applied to the housing of the flexible data storage card 124 can result in excessive wear, thus minimizing the useful life cycle of the data storage card 124.

Conversely, it is desired to maintain the pressure P₁ within the footprint of the reference head 70 at a relatively larger pressure to ensure a wobble-free path of the media disc 28 during rotation. In addition, the control of the pressure P₁ within the footprint of the reference head 70 assists in rapidly achieving dynamic equilibrium of the moving media disc 28 between the reference head 70 and the read/write head 126. It has been discovered that the non-planar reference surface 74 results in the media disc 28 rapidly reaching a stable equilibrium path in the direction of the arrow 130 when “spun-up” during a read/write operation.

The air slots 86, 88 are formed in the non-planar reference surface 74 and function to equalize pressure across the non-planar reference surface 74. The air slots 86, 88 dissipate the pressure P₂ outside of the footprint of the reference head 70 while the non-planar reference surface 74 contributes to the formation and maintenance of the pressure P₁ within the footprint of the reference head 70.

In addition, the air slots 86, 88 can be selectively configured to affect a magnitude of the pressure P₁ within the footprint of the reference head 70. In particular, variations in the depth/width, shape, and location of the air slots 86, 88 affect the magnitude of the pressure P₁ within the footprint of the reference head 70. For instance, FIGS. 5, 6, and 8 illustrate but one example of the location and conformation of the air slots 86, 88. It is to be understood that the air slots 86, 88 can be spaced to be further apart (or closer together) to accommodate various shapes and sizes of read/write heads. In the manner described above, an appropriately large pressure P₁ within the footprint of the reference head 70 can be developed, maintained, and distributed across the non-planar reference surface 74, and an appropriately low pressure P₂ outside of the footprint of the reference head 70 can be maintained such that the media disc 28 rotates (i.e., “flies”) in equilibrium between the reference head 70 and the read/write head 126 without unduly stressing the housing of the flexible data storage card 124.

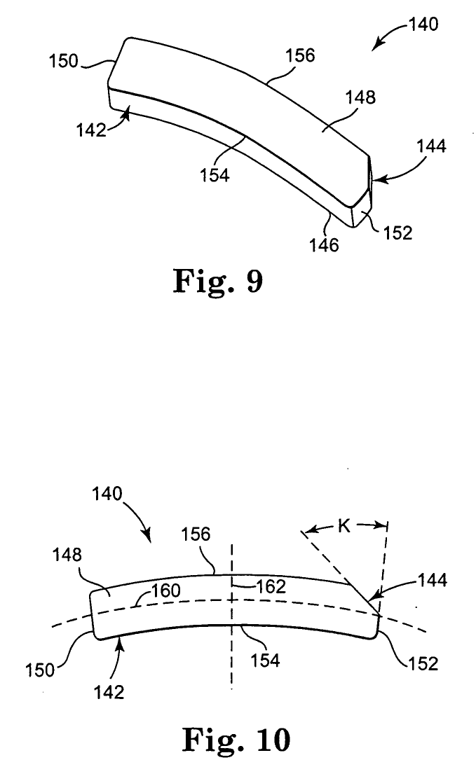

A non-symmetric reference head according to one embodiment of the present invention is illustrated in a perspective view at 140 in FIG. 9. The non-symmetric reference head 140 includes a body 142 and a location feature 144 formed in the body 142. The body 142 defines a first planar surface 146 opposite an optically smooth second planar surface 148. In addition, the body 142 defines a first side 150 and an opposing second side 152, and a leading edge 154 opposite a trailing edge 156. With this in mind, the opposing first and second sides 150, 152, the leading edge 154 and the trailing edge 156, and the location feature 144 bound the optically smooth second planar surface 148. It is desired that the location feature 144 be formed in the body 142 with minimum affect on the optically smooth second planar surface 148 such that the ability of the optically smooth second planar surface 148 to form an air bearing surface is unimpeded. In one embodiment, the optically smooth second planar surface 148 is characterized by an average surface roughness of not greater than 8 micro-inches.

In one embodiment, the location feature 144 is an angled face extending between the second side 152 and the trailing edge 156, however, it should be understood that the location feature 144 could be formed to extend between either of the opposing sides 150, 152 and the leading edge 154.

FIG. 10 is a top plan view of the non-symmetric reference head 140 shown in FIG. 9. The location feature 144 has been formed in the body 142 as an angled face inclined relative to the second side 152 by the angle K. In one embodiment, the angle K is between 0 and 90 degrees, preferably between 10 and 60 degrees, and more preferably the angle K is approximately 45 degrees. In this manner, the reference head 140 is non-symmetric relative to the longitudinal axis 160 and relative to the lateral axis 162.

During an assembly operation, and with additional reference to FIG. 1, it is desired to attach the reference head 140 to the interior surface 36 of the card top 30 such that the optically smooth second planar surface 148 is oriented toward the flexible media disc 28. The location feature 144 permits automated (for example, an optical pick-and-place assembly) or manual placement of the reference head 140 into a desired orientation where the first planar surface 146 is attached to the interior surface 36 of the card top 30 and the optically smooth second planar surface 148 is oriented toward the flexible media disc 28. That is to say, the location feature 144 is recognizable by both automated (machine) operators and human operators, and thus permits a reproducible orientation of the optically smooth second planar surface 148 toward the flexible media disc 28. To this end, the location feature 144 is a marked improvement over the known symmetric reference heads that fail to provide any indication of the orientation of the optically smooth surface relative to the card surface. As a point of reference, when a reference head is incorrectly mounted such that the optically smooth surface is adhered to the card top, then the optically smooth reference surface is not available for reference by the read/write head. An incorrect positioning of the reference head can cause potential instabilities in the aerodynamic air bearing formed by a rotating media disc, and can thus initiate a wobble in the rotation of the media disc.

Although specific embodiments have been illustrated and described for purposes of description of the preferred embodiment, it will be appreciated by those of ordinary skill in the art that a wide variety of alternate and/or equivalent implementations calculated to achieve the same purposes may be substituted for the specific embodiments shown and described without departing from the scope of the present invention. Those with skill in the chemical, mechanical, electro-mechanical, electrical, and computer arts will readily appreciate that the present invention may be implemented in a very wide variety of embodiments. This application is intended to cover any adaptations or variations of the preferred embodiments discussed herein. Therefore, it is intended that this invention be limited only by the claims and the equivalents thereof.

What is claimed is:

1. A flexible data storage card comprising:
a card top and a base coupled together to form a housing;
a media disc rotatably disposed within the housing and including a media side opposite a non-media side; and
a reference head disposed within the housing and defining a planar card surface opposite a non-planar reference surface;
wherein the planar card surface is coupled to an interior surface of the card top such that the non-planar reference surface is adjacent the non-media side of the media disc.

2. A reference head for use in a flexible data storage card comprising:
a planar card surface for attachment to an interior housing surface of the flexible data storage card; and
a non-planar reference surface opposite the planar card surface.

3. The reference head of claim 2, wherein the non-planar reference surface includes a leading edge adjacent the planar card surface and a trailing edge offset from the planar card surface.

4. The reference head of claim 3, wherein the non-planar reference surface defines a curved surface extending between the leading edge and the trailing edge, the curved surface extending through not greater than 180 degrees.

5. The reference head of claim 3, wherein the non-planar reference surface defines a curved surface extending between the leading edge and the trailing edge, the curved surface extending through 90 degrees.

6. The reference head of claim 3, wherein the non-planar reference surface defines a curved surface extending between the leading edge and the trailing edge, the curved surface defining a varying radius of curvature.

7. The reference head of claim 3, further comprising:
a back surface orthogonal to the planar card surface.

8. The reference head of claim 7, wherein the back surface is parallel to the leading edge, and further wherein the back surface and the leading edge are curved.

9. The reference head of claim 8, wherein the back surface and the leading edge curve through an angular displacement of at least 17 degrees.

10. The reference head of claim 2, further comprising:
a first side opposite a second side;
wherein the non-planar reference surface defines at least one air slot extending between the first side and the second side.

11. The reference head of claim 10, wherein the non-planar reference surface defines two separate air slots extending between the first side and the second side.

12. The reference head of claim 10, wherein the at least one air slot defines a U-shape in lateral cross-section.

13. The reference head of claim 2, wherein the planar card surface defines a rectangular footprint.

14. The reference head of claim 2, wherein the non-planar reference surface is optically smooth.

15. The reference head of claim 2, wherein the non-planar reference surface is characterized by an average surface roughness of not greater than 8 micro-inches.

16. A non-symmetric reference head for use in a flexible data storage card housing a rotatable media disc, the non-symmetric reference head comprising:
a body defining a first planar surface opposite an optically smooth second planar surface; and
a location feature formed in the body;
wherein the location feature is configured to reproducibly orient the optically smooth second planar surface toward the rotatable media disc.

17. The non-symmetric reference head of claim 16, wherein the location feature defines a region of non-symmetry relative to one of a longitudinal axis and a lateral axis.

18. The non-symmetric reference head of claim 16, wherein the body further defines opposing first and second sides and a leading edge opposite a trailing edge, and further wherein the location feature is an angled face extending between one of the opposing first and second sides and one of the leading edge and the trailing edge.

19. The non-symmetric reference head of claim 18, wherein the angled face extends between one of the opposing first and second sides and trailing edge.

20. The non-symmetric reference head of claim 18, wherein the angled face reposes at an angle in the range of 0-60 degrees relative to one of the opposing first and second sides.
